(19) United States
(12) Patent Application Publication
(10) Pub. No.: US 2006/0187757 A1
(43) Pub. Date: Aug. 24, 2006

(54) Radio-controlled timepiece

(76) Inventor: Tomohiro Ihashi, Chiba-shi (JP)

Correspondence Address: BRUCE L. ADAMS, ESQ.;SUITE 1231, 17 BATTERY PLACE, NEW YORK, NY, 10004, US

(21) Appl. No.: 11/356,629

(22) Filed: Feb. 17, 2006

(30) Foreign Application Priority Data
Feb. 22, 2005 (JP) 2005-046135

(51) Int. Cl. G04C 11/02

(52) U.S. Cl. 368/47

(57) ABSTRACT

To make it possible by a simple constitution to display a reception sensitivity. An antenna receives a standard wave, and a reception circuit extracts a time code contained in the standard wave, thereby outputting it to a control circuit. The control circuits detects, in a common region where a signal level of each bit constituting the time code ought to become the same, the signal level of the bit, and judges a goodness/badness of the reception sensitivity on the basis of the number of the bit in which the signal level has become a predetermined level within a predetermined time, thereby notifying by displaying it to a display section.

### BACKGROUND OF THE INVENTION

1. Field of the Invention

The present invention relates to a radio-controlled timepiece which receives by a radio wave a time code containing an information of a present time instant, and in which a clock time instant is corrected to a time instant corresponding to the time code.

2. Description of the Prior Art

From old times, there is developed the radio-controlled timepiece which receives the time code containing the information of a correct present time instant by the radio wave, thereby automatically correcting the clock time instant.

At present, in each state (e.g., Japan, the USA, Germany, UK, or the like), a long wave standard wave in which the time code that is a time instant information has been superimposed is transmitted from a radio station provided in a predetermined place. In Japan, the long wave standard waves of 40 kHz and 60 kHz respectively having been amplitude-modulated by the time code of a predetermined format are transmitted from two transmitting stations. The radio-controlled timepiece is constituted such that it receives this long wave standard wave, thereby correcting a time instant clocked by its clocking means to a time instant corresponding to the time code and displaying an accurate present time instant to a display section.

Generally, in most of the radio-controlled timepieces, there is possessed a function of a reception sensitivity notification showing whether an environment in which the radio-controlled timepiece is located at present exists in an environment capable of well receiving the radio wave or exists in a circumstance in which the reception is difficult, and there is adapted such that, on the basis of the reception sensitivity notification, a user can know whether or not it is possible to correct to an accurate time instant (e.g., refer to Patent Documents 1, 2).

In an invention disclosed in the JP-A-2002-6066 Gazette, there is constituted such that it is detected whether an edge of each bit of one second cycle constituting the time code is a regular cycle, thereby notifying a reception sensitivity while being displayed. For this reason, since it is necessary to detect the edge of the bit every one second and additionally, accurately measure an edge interval, there is a problem that a processing is very intricate and a constitution becomes complicated.

Further, in an invention described in the JP-A-2003-11428 Gazette, although it is one in which the reception sensitivity is notified by reflecting the number of error bits in a predetermined time to the reception sensitivity and it is considered to be effective, in order to judge as the error bit, it is necessary to continuously obtain 1 second data that is a time of 1 bit data and an analysis of the obtained data must be performed, so that there is a problem that the processing becomes intricate and, further, the constitution becomes complicated.

The present invention is one made in order to solve the above problems, and its object is to make it possible by a simple constitution to display the reception sensitivity.

### SUMMARY OF THE INVENTION

According to the present invention there is provided a radio-controlled timepiece which receives by a radio wave a time code containing an information of a present time instant and in which a clock time instant is corrected to a time instant corresponding to the received time code, characterized by comprising while possessing a notification means, and a control means which detects, in a common region where a signal level of each bit constituting the time code ought to become a predetermined same level, the signal level of the bit, which judges a goodness/badness of a reception sensitivity on the basis of the number of the bit in which the signal level has become a predetermined level within a predetermined time, and which notifies the goodness/badness of the reception sensitivity by the notification means.

The control means detects, in the common region where the signal level of each bit constituting the time code ought to become the predetermined same level, the signal level of the bit, judges the goodness/badness of the reception sensitivity on the basis of the number of the bit in which the signal level has become the predetermined level within the predetermined time, and notifies the goodness/badness of the reception sensitivity by the notification means.

Here, there maybe constituted such that the control means has a 1st counter means for counting the number of the bit in which the signal level in the common region is the predetermined level, a 2nd counter means for clocking a time, and a judgment means for judging the goodness/badness of the sensitivity on the basis of a count value that the 1st counter means has counted during the 2nd counter means clocks for the predetermined time, and the judgment means judges, in a case where the count value that the 1st counter means has counted during the 2nd counter means clocks for the predetermined time is higher than a predetermined value, that the sensitivity is good, thereby performing a notification that the sensitivity is good by the notification means.

Further, there may be constituted such that the judgment means judges, in a case where the count value that the 1st counter means has counted during the 2nd counter means clocks for the predetermined time does not reach to the predetermined value, that the sensitivity is bad, thereby performing a notification that the sensitivity is bad by the notification means.

Further, there may be constituted such that the common region is an initial predetermined time region or a last predetermined time region of each bit.

### BRIEF DESCRIPTION OF THE SEVERAL VIEWS OF THE DRAWINGS

A preferred form of the present invention is illustrated in the accompanying drawings in which:

FIG. 1 is a block diagram of a radio-controlled timepiece concerned with an embodiment of the present invention;

FIGS. 2 are waveform diagrams of each bit constituting a time code in Japan;

FIG. 3 is a flowchart showing processings in the radio-controlled timepiece concerned with the embodiment of the present invention;

FIG. 4 is a flowchart showing processings in the radio-controlled timepiece concerned with other embodiment of the present invention;

FIGS. 5 are waveform diagrams of each bit constituting a time code in the USA;

FIGS. 6 are waveform diagrams of each bit constituting a time code in Germany; and

FIGS. 7 are waveform diagrams of each bit constituting a time code in UK.

### DETAILED DESCRIPTION OF THE PREFERRED EMBODIMENTS

Hereunder, it is explained about a radio-controlled timepiece concerned with an embodiment of the present invention.

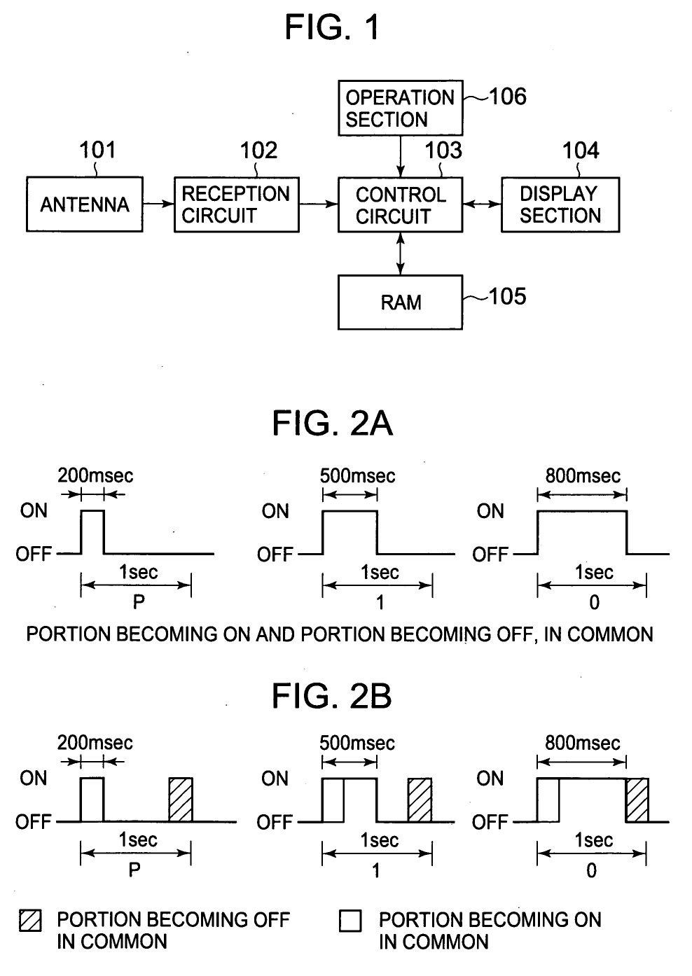

FIG. 1 is a block diagram of the radio-controlled time piece concerned with the embodiment of the present invention. In FIG. 1, the radio-controlled timepiece has an antenna 101 constituted by an antenna coil, a reception circuit 102 for extracting and outputting the time code contained in a standard wave signal received by the antenna 101, a control circuit 103 as a control means which is constituted by a central processing unit (CPU) and performs a control of each constituent element and the whole of the radio-controlled timepiece, or the like, a display section 104 as a notification means which is constituted by a liquid crystal display or the like and performs a display of the present time instant and a notification of the goodness/badness of the reception sensitivity, or the like, a memory (Random Access Memory: RAM) 105 as a storage means for storing a program that the control circuit 103 implements, various data or the like, and an operation section 106 as an operation means.

Incidentally, as mentioned later, the control circuit 103 constitutes together with the memory 105 a 1st counter means for counting the number of bits in which a signal level in a time region (common region) where the signal level of each bit constituting the time code ought to become a predetermined same level is a predetermined level, and a 2nd counter means for clocking a predetermined time. Every time counted by the 1st counter means and the 2nd counter means, there is added to a count value stored in the memory 105.

Further, the control circuit 103 constitutes also a judgement means for judging the goodness/badness of the sensitivity on the basis of the count value that the 1st counter means has counted during the 2nd counter means clocks for the predetermined time.

FIGS. 2 are waveform diagrams of the bit constituting a time code (JJY) used in Japan. As shown in FIG. 2A, in the time code there are contained three kinds of bits of a P code denoting a position, a code denoting “1”, and a code denoting “0”. Incidentally, there is constituted such that a just minute position (reference maker) is denoted by the two continuous P codes.

As shown in FIG. 2A, each bit is a signal of 1 second cycle, the P code is a signal in which the signal level becomes a high level (ON level) for initial 200 msec of the bit and becomes a low level (OFF level) for last 800 msec, the code denoting “1” is a signal in which the signal level becomes the high level for initial 500 msec of the bit and becomes the low level for last 500 msec, and the signal denoting “0” is a signal in which the signal level becomes the high level for initial 800 msec of the bit and becomes the low level for last 200 msec.

As shown in FIG. 2B, each bit has a common region where the signal levels become mutually the same. That is, there is constituted such that an initial predetermined time region (in FIGS. 2, the initial 200 msec) and a last predetermined time region (in FIGS. 2, the last 200 msec) of each bit become respectively the same level of the high level and the low level. The radio-controlled timepiece concerned with the present embodiment utilizes a characteristic like this of each bit constituting the time code when detecting the goodness/badness of the reception sensitivity.

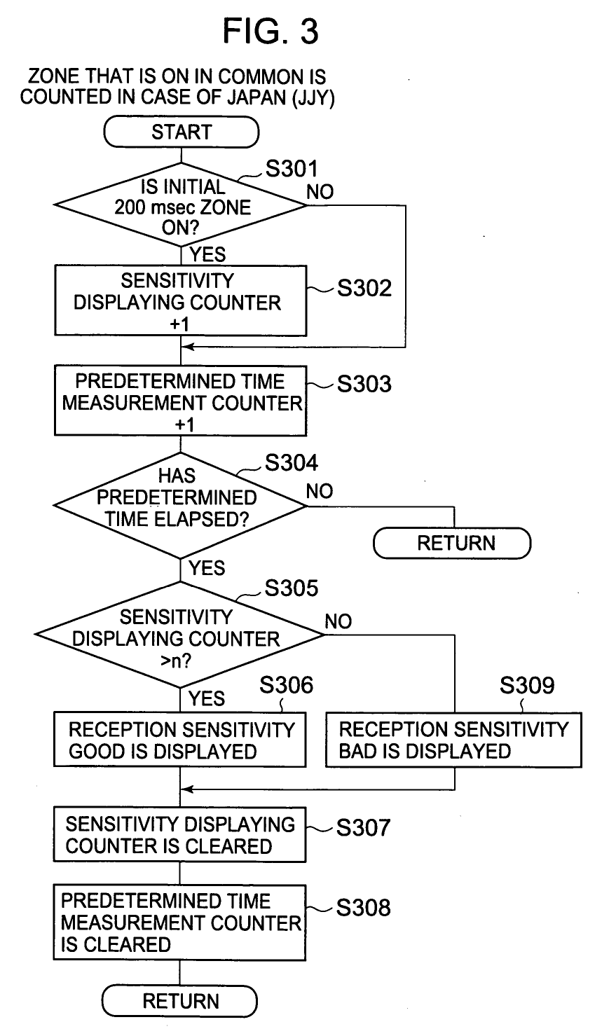

FIG. 3 is a flowchart showing processings in the radio-controlled timepiece of FIG. 1, and shows mainly the processings performed by the fact that the control circuit 103 implements the program previously stored in the memory 105.

Hereunder, by using FIG. 1-FIG. 3, operations in the radio-controlled timepiece concerned with the present embodiment are detailedly explained. Incidentally, the present embodiment is an example of judging the goodness/badness of the reception sensitivity by utilizing the fact that, in the bit constituting the time code, the initial predetermined time region (zone of 200 msec) that is the common region is the high level (ON).

In the radio-controlled timepiece, when it has reached to a time instant previously stored in the memory 105 or when the user has instructed a time instant correction processing by operating the operation section 106, the control circuit 103 detects this, thereby commencing the time instant correction processing.

If the time instant correction processing is commenced, as to the plural bits constituting the received time code, the control circuit 103 judges in order whether or not the signal level of one point in a initial predetermined time region (initial 200 msec zone in the present embodiment) of the bit is the high level (ON) (step S301).

Every time judged in the step S301 that it is the high level as to each bit, the control circuit 103 adds 1 to the count value (i.e., count value (corresponding to a bit number) stored in the memory 105) of a sensitivity displaying counter as the 1st counter means (step S302).

Here, since 1 second elapses, after 1 has been added to the count value (i.e., count value (corresponding to a clock time) stored in the memory 105) of a predetermined time measurement counter as the 2nd counter means (step S303), it is judged whether or not a predetermined time (e.g., 10 seconds) has elapsed (step S304).

Next, it is judged whether or not the sensitivity displaying counter is larger than a predetermined value n (e.g., 9) (step S305) and, in a case where the count value of the sensitivity displaying counter is larger than the n, there is displayed as reception sensitivity good (GOOD) in the display section 104, thereby notifying (step S306).

Next, the control circuit 103 clears the sensitivity displaying counter (step S307) and, after the predetermined time measurement counter has been cleared (step S308), it returns to the step S301. By this, the count value having been stored in the memory 105 is cleared.

On the other hand, in a case where the control circuit 103 has judged in the step S301 that the signal level of the initial 200 msec zone is not the high level (low level), it shifts to the step S303, thereby performing the above processings.

In a case where the control circuit 103 has judged in the step S304 that the predetermined time does not elapse still, it returns to the step S301, thereby repeating the above processings.

Further, in a case where in the step S305 the count value of the sensitivity displaying counter does not reach to the predetermined value n, after the control circuit 103 has notified by displaying as reception sensitivity bad (BAD) to the display section 104 (step S309), it shifts to the step S307, thereby performing the above processings.

Like this, there is adapted such that there is notified in the display section 104 by detecting the signal level in the common region (in the present embodiment, the initial 200 msec zone) where the signal level of each bit constituting the time code ought to be common, and judging the goodness/badness of the reception sensitivity on the basis of the number of the bit in which the signal level within the predetermined time has become the predetermined level. Accordingly, it is possible to judge the reception sensitivity of the standard wave on the basis of the number of times in which the signal of the predetermined level has occurred in the common region of the bit constituting the time code, so that the processing is simple and it becomes possible to perform the notification of the reception sensitivity by the simple constitution.

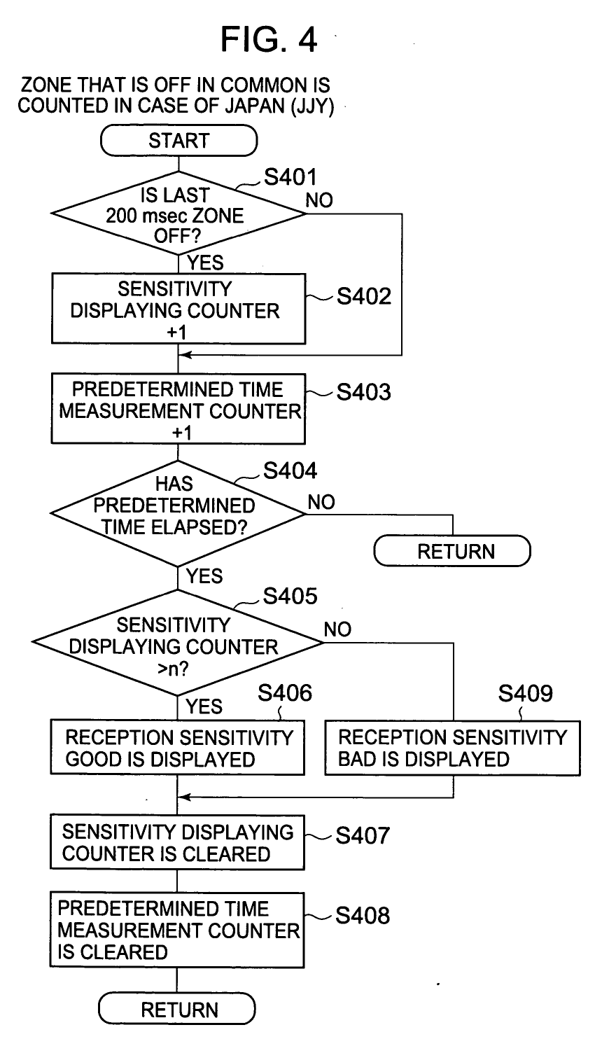

FIG. 4 is a flowchart showing the processings in the radio-controlled timepiece concerned with other embodiment of the present invention. A circuit block diagram of the radio-controlled time piece concerned with the present embodiment is the same as FIG. 1. In the above embodiment, although the goodness/badness of the reception sensitivity has been judged by making the initial predetermined time region (zone of the initial 200 msec) into the common region, and utilizing the fact that the signal level in the common region is the high level (ON), in the present embodiment there is constituted such that the goodness/badness of the reception sensitivity is judged by making the last predetermined time region (zone of the last 200 msec) into the common region, and utilizing the fact that the signal level in the common region is the low level (OFF).

Hereunder, by using FIG. 1 and FIG. 4, the operations in the radio-controlled timepiece concerned with the present embodiment are explained.

In the radio-controlled timepiece, when it has reached to the time instant previously stored in the memory 105 or when the user has instructed the time instant correction processing by operating the operation section 106, the control circuit 103 detects this, thereby commencing the time instant correction processing.

If the time instant correction processing is commenced, as to the plural bits constituting the received time code, the control circuit 103 judges in order whether or not the signal level of one point in the last predetermined time region (last 200 msec zone in the present embodiment) of the bit is the low level (OFF) (step S401).

Every time judged in the step S401 that it is the low level as to each bit, the control circuit 103 adds 1 to the count value (i.e., count value (corresponding to the bit number) previously stored in the memory 105) of the sensitivity displaying counter as the 1st counter means (step S402).

Here, since 1 second elapses, after 1 has been added to the count value (i.e., count value (corresponding to a clock time) stored in the memory 105) of the predetermined time measurement counter as the 2nd counter means (step S403), it is judged whether or not the predetermined time (e.g., 10 seconds) has elapsed (step S404).

Next, it is judged whether or not the count value of the sensitivity displaying counter is larger than the predetermined value n (e.g., 9) (step S405) and, in the case where the count value of the sensitivity displaying counter is larger than the n, there is displayed as reception sensitivity good (GOOD) in the display section 104, thereby notifying (step S406).

Next, the control circuit 103 clears the sensitivity displaying counter (step S407) and, after the predetermined time measurement counter has been cleared (step S408), it returns to the step S401. By this, the count value having been stored in the memory 105 is cleared.

On the other hand, in the case where the control circuit 103 has judged in the step S401 that the signal level of the initial 200 msec zone is not the low level (high level), it shifts to the step S403, thereby performing the above processings.

In the case where the control circuit 103 has judged in the step S404 that the predetermined time does not elapse still, it returns to the step S401, thereby repeating the above processings.

Further, in the case where in the step S405 the count value of the sensitivity displaying counter does not reach to the predetermined value n, after the control circuit 103 has notified by displaying as reception sensitivity bad (BAD) to the display section 104 (step S409), it shifts to the step S407, thereby performing the above processings.

Like this, there is adapted such that there is notified in the display section 104 by detecting the signal level in the common region (in the present embodiment, the last 200 msec) where the signal level of each bit constituting the time code is common, and judging the goodness/badness of the reception sensitivity on the basis of the number of the bit in which the signal level within the predetermined time has become the predetermined level. Accordingly, it is possible to judge the reception sensitivity of the standard wave on the basis of the number of times in which the signal of the predetermined level has occurred in the common region of the bit constituting the time code, so that the processing is simple and it becomes possible to perform the notification of the reception sensitivity by the simple constitution.

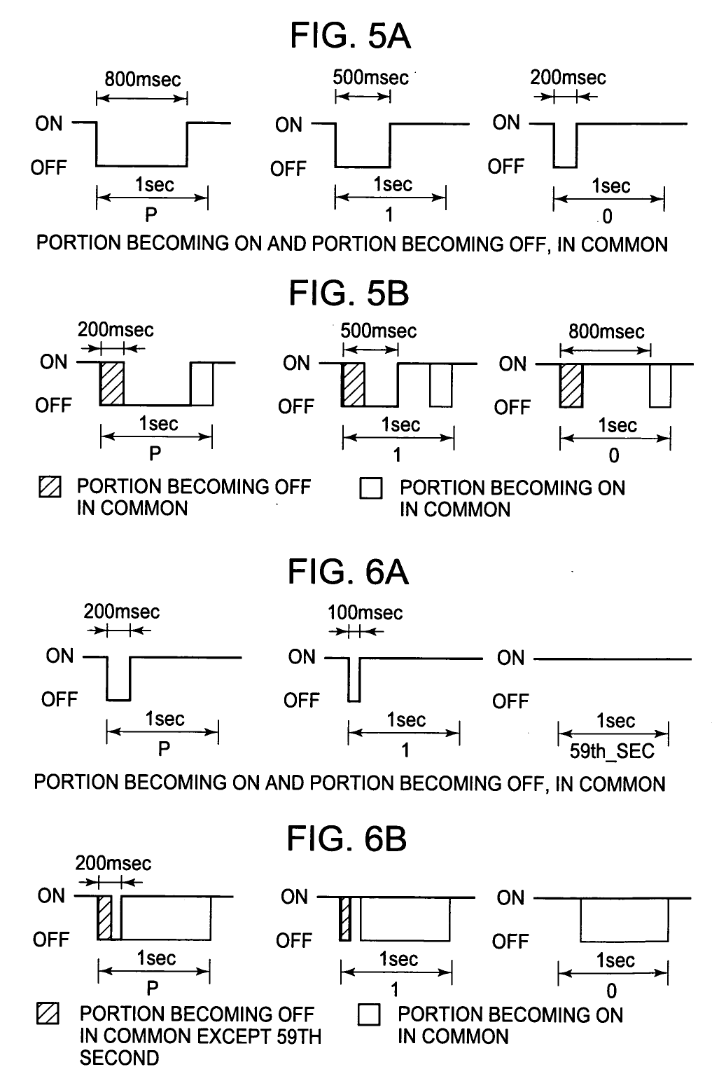

FIGS. 5 are waveform diagrams of each bit of a time code (WWVB) used in the USA. As shown in FIG. 5A, in the time code there are contained three kinds of bits of the P code denoting the position, the code denoting “1”, and the code denoting “0”.

As shown in FIG. 5A, each bit is the signal of 1 second cycle, the P code is a signal in which the signal level becomes the low level (OFF level) for initial 800 msec of the bit and becomes the high level (ON level) for last 200 msec, the signal denoting “1” is a signal in which the signal level becomes the low level for initial 500 msec of the bit and becomes the high level for last 500 msec, and the signal denoting “0” is a signal in which the signal level becomes the low level for initial 200 msec of the bit and becomes the high level for last 800 msec.

As shown in FIG. 5B, each bit has the common region where the signal levels become mutually the same. That is, there is constituted such that the initial predetermined time region (in FIGS. 5, the initial 200 msec) of each bit and the last predetermined time region (in FIGS. 5, the last 200 msec) of each bit become respectively the same level of the low level and the high level.

In the USA, it is possible to perform the notification of the reception sensitivity similarly to the above embodiment by utilizing the common region of each bit while using the time code shown in FIGS. 5.

FIGS. 6 are waveform diagrams of each bit of a time code (DCF77) used in Germany. As shown in FIG. 6A, in the time code there are contained three kinds of bits of the P code denoting the position, the code denoting “1”, and a code denoting 59th second.

As shown in FIG. 6A, each bit is the signal of 1 second cycle, the P code is a signal in which the signal level becomes the low level (OFF level) for initial 200 msec of the bit and becomes the high level (ON level) for last 800 msec, the signal denoting “1” is a signal in which the signal level becomes the low level for initial 100 msec of the bit and becomes the high level for last 900 msec, and the signal denoting 59th second is a signal in which the signal level becomes the high level for 1 second from the beginning to the last of the bit.

As shown in FIG. 6B, each bit has the common region where the signal levels become mutually the same. That is, there is constituted such that the last predetermined time region (in FIGS. 6, the last 800 msec) of each bit becomes the same level of the high level.

In Germany, it is possible to perform the notification of the reception sensitivity similarly to the above embodiment by utilizing the common region of each bit while using the time code shown in FIGS. 6.

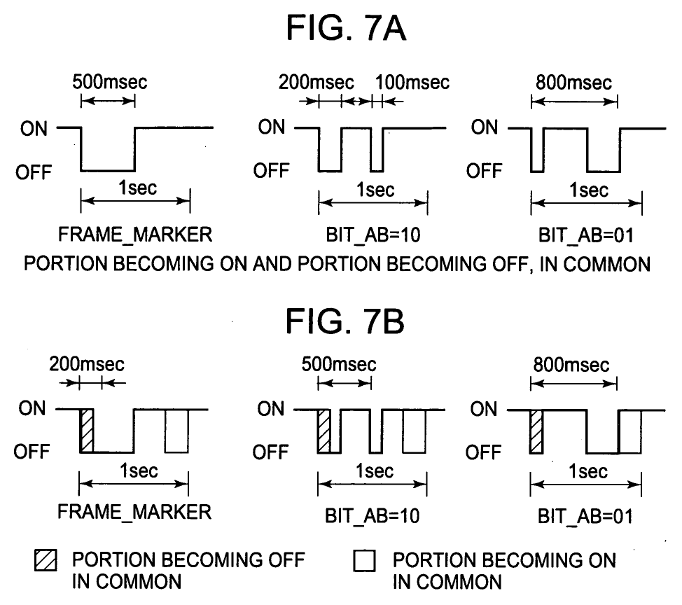

FIGS. 7 are waveform diagrams of each bit of a time code (MSF) used in UK. As shown in FIG. 7A, in the time code there are contained three kinds of bits of a frame marker denoting a head of frame, a code denoting “10”, and a code denoting “01”.

As shown in FIG. 7A, each bit is the signal of 1 second cycle, the frame marker is a signal in which the signal level becomes the low level (OFF level) for initial 500 msec of the bit and becomes the high level (ON level) for last 500 msec, the signal denoting “10” is a signal in which the signal level becomes the low level for initial 200 msec of the bit and 100 msec from 500 msec and becomes the high level for last 400 msec, and the signal denoting “01” is a signal in which the signal level becomes the low level for initial 100 msec of the bit and during a period from 500 msec to 800 msec and becomes the high level for last 200 msec.

As shown in FIG. 7B, each bit has the common region where the signal levels become mutually the same. That is, there is constituted such that the initial predetermined time region (in FIGS. 7, the initial 100 msec) of each bit and the last predetermined time region (in FIGS. 7, the last 200 msec) of each bit become respectively the same level of the low level and the high level.

In UK, it is possible to perform the notification of the reception sensitivity similarly to the above embodiment by utilizing the common region of each bit while using the time code shown in FIGS. 7.

As mentioned above, according to the radio-controlled timepiece concerned with the above embodiment, there are possessed—in the radio-controlled timepiece which receives by the radio wave the time code containing the information of the present time instant and in which the clock time instant is corrected to the time instant corresponding to the received time code—the display section 104 as the notification means, and the control circuit 103 which detects, in the common region where the signal level of each bit constituting the time code ought to become the predetermined same level, the signal level of the bit, which judges the goodness/badness of the reception sensitivity on the basis of the number of the bit in which the signal level has become the predetermined level within the predetermined time, and which notifies the goodness/badness of the reception sensitivity by the display section 104.

Here, there is adapted such that the control circuit 103 has the 1st counter means (the processing steps S302, S402) for counting the number of the bit in which the signal level in the common region is the predetermined level, the 2nd counter means (the processing steps S303, 403) for clocking the time, and the judgment means (the processing steps S 304, S305, S404, S405) for judging the goodness/badness of the sensitivity on the basis of the count value that the 1st counter means has counted during the 2nd counter means clocks for the predetermined time, and the judgment means judges, in the case where the count value that the 1st counter means has counted during the 2nd counter means clocks for the predetermined time is higher than the predetermined value, that the sensitivity is good, thereby performing the notification that the sensitivity is good by the display section 104.

Further, there is adapted such that the judgment means judges, when the count value that the 1st counter means has counted during the 2nd counter means clocks for the predetermined time does not reach to the predetermined value, that the sensitivity is bad, thereby performing the notification that the sensitivity is bad by the display section 104.

Accordingly, it becomes possible by the simple constitution to notify the goodness/badness of the reception sensitivity without performing the complicated processings.

Incidentally, in the above embodiment, although the goodness/badness of the reception sensitivity has been visually notified by displaying to the display section 104, there may be adapted so as to notify by other method such as aurally notifying by a sound. Further, there can be applied also to the radio-controlled timepiece utilized in a state where the time code having the common region is used, not only in the states mentioned before.

There can be applied also to the radio-controlled timepiece utilized in the state where the time code having the common region is used, without being limited to Japan, the USA, or the like.

According to the present invention, it becomes possible by the simple constitution to notify the goodness/badness of the reception sensitivity without performing complicated processings.

What is claimed is:

1. A radio-controlled timepiece comprising:
reception means for receiving by a radio wave a time code containing an information of a present time instant;
notification means, and
control means which detects, in a common region where a signal level of each bit constituting the time code ought to become a predetermined same level, the signal level of the bit, which judges a goodness/badness of a reception sensitivity on the basis of the number of the bit in which the signal level has become a predetermined level within a predetermined time, and which notifies the goodness/badness of the reception sensitivity by the notification means and which a clock time instant is corrected to a time instant corresponding to the received time code.

2. A radio-controlled timepiece according to claim 1, wherein the control means has 1st counter means for counting the number of the bit in which the signal level in the common region is the predetermined level, 2nd counter means for clocking a time, and judgment means for judging the goodness/badness of the sensitivity on the basis of a count value that the 1st counter means has counted during the 2nd counter means clocks for the predetermined time, and the judgment means judges, in a case where the count value that the 1st counter means has counted during the 2nd counter means clocks for the predetermined time is higher than a predetermined value, that the sensitivity is good, thereby performing a notification that the sensitivity is good by the notification means.

3. A radio-controlled timepiece according to claim 2, wherein the judgment means judges, in a case where the count value that the 1st counter means has counted during the 2nd counter means clocks for the predetermined time does not reach to the predetermined value, that the sensitivity is bad, thereby performing a notification that the sensitivity is bad by the notification means.

4. A radio-controlled timepiece according to claim 1, wherein the common region is an initial predetermined time region or a last predetermined time region of each bit.
